(19) United States
(12) Patent Application Publication
(10) Pub. No.: US 2026/0256037 A1
(43) Pub. Date: Sep. 3, 2026

(54) METHOD FOR DETERMINING SEMI-AUTOMATICALLY PATHS TO BE FOLLOWED BY AT LEAST ONE AGRICULTURAL ROBOT TO WORK A PLOT

(71) Applicant: KUHN SAS, Saverne (FR)

(72) Inventors: Marie HOELLINGER, Rimling (FR); Quentin LABOUREY, Ostwald (FR)

(73) Assignee: KUHN SAS, Saverne (FR)

(21) Appl. No.: 19/163,570

(22) PCT Filed: Mar. 14, 2024
(86) PCT No.: PCT/EP2024/056786

§ 371 Date: Sep. 9, 2025

(30) Foreign Application Priority Data
Mar. 16, 2023 (FR) FR2302426

(51) Int. Cl. A01B 69/04; G05D 1/24; G05D 1/644; G05D 1/648; G05D 105/15; G05D 107/20; G05D 109/10

(52) U.S. Cl. CPC A01B 69/008; G05D 1/24; G05D 1/644; G05D 1/6482; G05D 2105/15; G05D 2107/21; G05D 2109/10

(57) ABSTRACT

A method for determining semi-automatically the passages and paths to be made by an agricultural robot in order to work a given plot of land in its entirety, includes: calculating paths parallel to an initial reference orientation, determining one or more non-optimal area(s), defining one other reference orientation and calculating paths parallel to it for each non-optimal area, repeating those operations if necessary and visualizing a configuration proposal of the planned movements for the entire plot.

### BACKGROUND OF THE INVENTION

### Field of the Invention

The present invention relates to the field of agricultural machinery and more particularly to the working of the soil or plants of an agricultural plot of land by at least one autonomous agricultural working machine, i.e. able to work the plot of land without the assistance of an operator, except for possible occasional intervention, and preferably without being under the control of a central control unit. Such a machine is commonly referred to as an agricultural robot and corresponds to a mobile, motorized agricultural machine or attachment fitted with at least one tool (integrated, mounted, semi-mounted or towed) and including integrated means (for control, communication, location, etc.) enabling it to work a plot of land autonomously, if necessary in cooperation with at least one other machine carrying out the same type of work or not.

In this context, the object of the invention is a method for determining semi-automatically the passages and paths to be worked by at least one agricultural robot in order to work a given plot of land in its entirety.

Such an agricultural robot can be used alone to work a plot of land, or as part of a fleet of at least two robots assigned to the plot. This robot can operate completely independently after parameterization and programming (before starting work in the field, directly by a user on site or remotely via a central control and management system). The robots in a fleet may or may not communicate with each other, and may or may not be assigned to work on a predetermined part of the plot.

Typically, an agricultural plot of land is worked by moving back and forth within it. In agricultural robotics, the trajectories taken by the machines are often generated in advance, in the form of pre-calculated planned paths or passages. These trajectories are generally (at least within the cultivated area of the plot) straight lines parallel to an edge of the plot, called the “reference edge”, which is straight, if possible, but not necessarily. These straight lines (paths or passages) are spaced apart by the working width of the tool or tools of the agricultural robot in question.

This solution is simple to implement and well suited to plots of land with basic geometric shapes (e.g. rectangles, squares, quadrilaterals) or at least with no concave or non-straight edges. But as soon as a plot has a more complex shape, includes an obstacle and/or has a certain topography or risk areas (which is often the case in real-life situations), then the trajectories are not necessarily optimized (in terms of number, length, safety during work, non-worked movements, etc.), if they are all parallel to a single orientation or direction or to a single reference edge (see, for example, FIG. 1A).

### Description of the Related Art

From document U.S. Pat. No. 10,459,447, a method is known for planning trajectories of agricultural robots for the production of swaths, which consists of defining one or more partitions of the plot, determining sets of swath trajectories by multiple angular incrementation, calculating for each set the difference in length between the longest trajectory and the shortest trajectory, and retaining the set of trajectories with the smallest difference.

From document EP 2 446 725, a method is known for determining a planned path for a vehicle, consisting of delimiting a plot of land by means of linear segments and concave connection nodes, identifying the concave surfaces of this plot, subdividing the plot into sectors by lines in relation to the aforementioned nodes, determining a reference direction of trajectories and defining the working paths in the sectors and the interconnection paths between sectors.

These known methods are systematically fully automatic, involve a complex methodology which first involves partitioning the plot in question, cannot be carried out optionally and partially by the user, and do not offer final validation or even selection by the user.

### SUMMARY OF THE INVENTION

The aim of the present invention is to overcome at least the main of these drawbacks.

To this end, its object is a method for determining semi-automatically the passages and paths to be made by at least one agricultural robot in order to work a given plot of land in its entirety, this method including the following steps:
a) defining, automatically or by a user, an initial reference orientation, advantageously in accordance with a reference edge of the plot in question,
b) calculating paths parallel to the initial reference orientation, so as to cover the entire plot,
c) automatically detecting one or more areas of the plot, with i varying from 2 to n, with n≥2, called non-optimal area(s), in which the evaluation, with respect to at least one predefined performance criteria related to the paths and/or work, of the planned paths in accordance with the initial reference orientation and of the resulting configuration of the projected movements, does not exceed a threshold value or does not reach a respectively predetermined optimal value,
d) automatically defining at least one other reference orientation for the or each non-optimal area(s),
e) calculate, for the or each non-optimal area, the paths parallel to the at least one other reference orientation defined for the non-optimal area in question, so as to cover this non-optimal area in its entirety in each case,
f) if necessary, repeating steps d) and e) for a given non-optimal area, defining a different reference orientation in each case, until at least one paths proposal is obtained for this non-optimal area, whose evaluation with respect to the at least one performance criteria reaches an optimal value,
g) visualizing the plot of land with at least one proposal for the configuration of the projected movements of the agricultural robot(s) in the different areas, each with its own paths orientations, these different areas, with i varying from 1 to n, together covering the entire surface of the plot of land.

### BRIEF DESCRIPTION OF THE DRAWINGS

The invention will be better understood from the following description, which refers to a preferred embodiment, given by way of non-limiting example and explained with reference to the appended schematic drawings, in which:

FIG. 1A is a schematic top view of a plot of land for which the planned paths of an agricultural robot have been determined in relation to a single reference edge and according to a single orientation;

FIG. 1B and FIG. 1C are identical views of the same parcel as FIG. 1A, with path determination in accordance with the method according to the invention and the use of two reference edges or orientations;

FIG. 2,

FIG. 3 and

FIG. 4 are schematic top views of two further plots of land for which the intended paths of an agricultural robot have been determined with the method according to the invention, in relation to at least three reference edges or orientations.

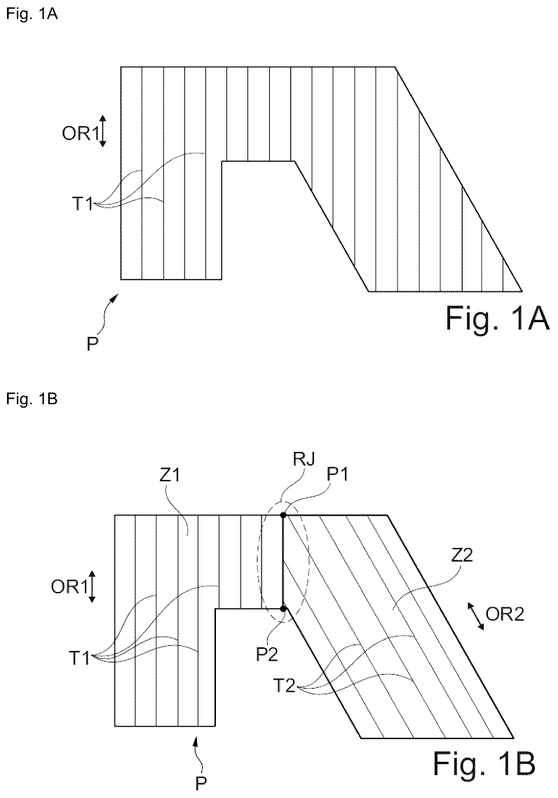

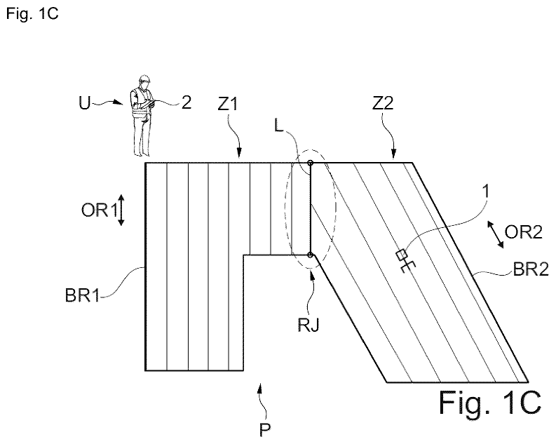

FIGS. 1B, 1C and 2 to 4 show, in accordance with the invention, the application to different geometric shapes and topographies of plots (P) of the method for semi-automatically determining the passages and paths (T) to be made by at least one agricultural robot (1) in order to work a given plot of land (P) in its entirety.

### DETAILED DESCRIPTION OF THE PREFERRED EMBODIMENTS

According to the invention, this method substantially comprises the following steps:
a) defining, automatically or by a user (U), an initial reference orientation (OR1), advantageously in accordance with a reference edge of the plot (P) in question,
b) calculating paths (T1) parallel to the initial reference orientation (OR1), so as to cover the entire plot (P),
c) automatically detecting one or more areas (Zi) of the plot (P), with i varying from 2 to n, with n≥2, called non-optimal area(s) (Zi), in which the evaluation, with respect to at least one predefined performance criteria related to the paths and/or work, of the planned paths (T1) in accordance with the initial reference orientation (OR1) and of the resulting configuration of the projected movements, does not exceed a threshold value or does not reach a respectively predetermined optimal value,
d) automatically defining at least one other reference orientation (ORi) for the (Z) or each (Z2 to Zn) non-optimal area(s) (Zi),
e) calculating, for the or each non-optimal area(s) (Zi), the paths (Ti) parallel to the at least one other reference orientation (ORi) defined for the non-optimal area (Zi) in question, so as to cover this non-optimal area (Zi) in its entirety in each case,
f) if necessary, repeating steps d) and e) for a given non-optimal area (Zi), defining a different reference orientation (ORi) in each case, until at least one path (Ti) proposal is obtained for this non-optimal area (Zi), whose evaluation with respect to the at least one performance criteria reaches an optimal value,
g) visualizing the plot of land (P) with at least one proposal for the configuration of the projected movements of the agricultural robot(s) (1) in the different areas (Zi), each with its own path (Ti) orientation (ORi), these different areas (Zi), with i varying from 1 to n, together covering the entire surface of the plot of land (P).

Thanks to this combination of particular features, the method according to the invention makes it possible to determine an optimized configuration of the paths to be made in order to work the entire plot of land (P) in question, the initial orientation (OR1) being definable either automatically by suitable software (in particular following a cartographic or geometric analysis of the plot; for example: OR1=direction of the longest straight line that can be traced in the plot) or manually by the user (U). When defining this initial orientation, knowledge acquired during previous work campaigns can also be taken into account.

In addition, this gradual, guided approach to determining the orientations, and then the working paths, of non-optimal areas makes it possible to explore and evaluate substantially all possible options in terms of proposed paths configurations (of course, T1 paths are retained for the rest of the plot (=plot-non-optimal areas), as optimal path configurations).

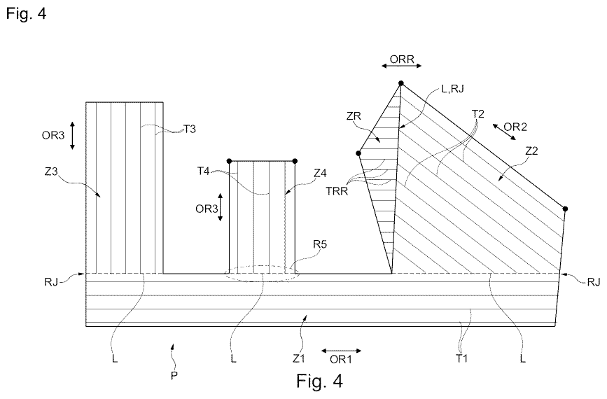

The same orientation (ORi) can possibly be applied to several distinct, unrelated constituent areas of the plot (see OR3 applied to Z3 and Z4 in FIG. 4).

In accordance with a preferred embodiment, the visualization of the projected movement configuration proposal(s) for the agricultural robot(s) (1) on the plot of land (P) divided into n zones (Zi) is carried out on an interactive graphic interface (2) and is characterized in that the proposal, possibly chosen from several after a justified selection, is subject to validation by a user (U) before being transmitted to the agricultural robot(s) (1), if necessary via a centralized management system of the latter(s). This way, the user regains control and decides on the configuration to be implemented, if necessary, after defining the initial orientation (step a).

Advantageously, and in particular when carried out automatically, the initial reference orientation (OR1) is defined, after taking into account the topographic and geometric features of the plot of land (P), by using at least one evaluation criteria chosen from among the following: a given number of projected paths (T1), for example a minimum number; a given number of U-turns, for example a minimum number; the longest possible uninterrupted edge-to-edge path (T), straight if possible; at least one optimized statistical parameter on the population of projected paths (T1) lengths, for example variance, average and/or median; whereby a weighting of the criteria can be applied if at least two criteria are used.

Preferably, the evaluation criteria used to detect areas (Zi) as not being likely to be travelled and/or worked efficiently enough in relation to the initial paths prediction (T1), is/are chosen from among the following: the topography and/or geometry of the plot of land (P); an average value of the paths' lengths that is as high as possible; a number of U-turns that is as low as possible; at least one statistical parameter optimized on the population of the projected paths' (T1) lengths, for example the variance, the average and/or the median; a weighting of the criteria possibly being applied when at least two criteria are used.

When multiple evaluation criteria are used, weighting may be used in order to prioritize one or more of them as being more important than the others.

The paths (Ti) planned on two areas (Zi) that touch each other may tend to overlap and cross each other in a junction region (RJ) between these two areas. To avoid this disruptive phenomenon, it may be possible to manage the configuration of paths in these regions, either automatically or through user intervention.

This way, and as shown in FIGS. 1C and 2 to 4, the method consists in defining limits (L) at the junction regions (RJ) between two abutting zones, among the various n zones (Zi) covering the entire surface of the plot (P), giving preference as criteria to a minimum number of paths (Ti), with i varying from 1 to n, to cover the entire plot (P) and/or a minimum number of U-turns within the plot (P) Preferably, the definition of each limit (L) at the junction region (RJ) between two abutting areas (Zi), with i varying from 1 to n, is achieved either by connecting two opposite points (P1, P2) of the peripheral edge surrounding the plot (P), or by extending the paths (Ti) of an area (Zi) from the peripheral edge to their intersection with another path (Ti) of greater length of another zone (Zi), this definition of the limits being carried out automatically or manually by a user (U) by means of an interactive graphic interface (2).

A limit (L), which may or may not be straight, is for example formed by at least a portion or the entirety of a bordering path (Ti), planned in one of the two abutting areas (Zi): it then has a real existence. However, such a limit (L) can also be of a virtual nature, defining a virtual edge between two abutting zones (FIG. 4).

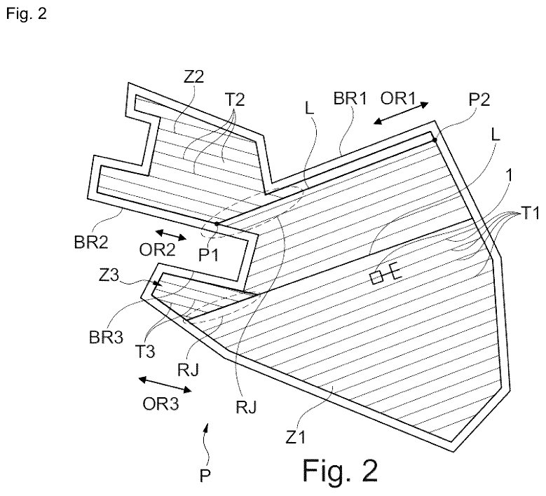

In order to take better account of the actual situation in the field, and in particular of factors disrupting the homogeneity and continuity of work in the plot to be worked, it may be envisaged to take into account during steps a), b), d) and e), on the basis of enhanced cartographic data of the plot (P) and for the definition of the initial reference orientation (OR1), and of at least one other possible reference orientation (ORi), as well as for the subsequent calculation of the paths (T1, Ti): one or more obstacles (O) that may be present in the plot (P) and/or one or more risk zones (ZR) that may be present in the plot (P), and/or the intended direction of movement during a subsequent agricultural operation (see FIGS. 2, 3 and 4).

Depending on its geometry, an obstacle (O) can itself determine a reference orientation or edge for path calculation. Furthermore, in the case of a risk zone (ZR), it may be planned to determine a specific orientation (ORR) for this zone, generating paths (TRR) that minimize the risk incurred (FIG. 4).

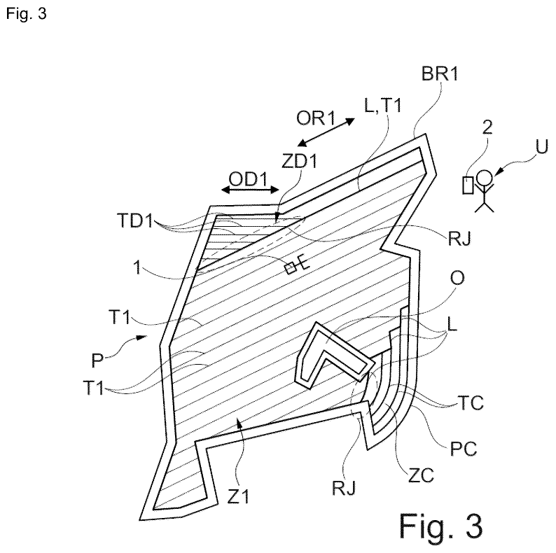

In addition or alternatively, in order to take into account the relief of the plot to be worked, it may be possible to take into account three-dimensional topographic data for the plot (P) in question, to identify the area(s) (ZDj) which may be on a slope and whose gradient is greater than a predetermined threshold value, and to impose a reference orientation (ODj) for the orientation of the paths (TDj), with j≥0, to be calculated for the or each agricultural robot(s) (1) in the or each aforementioned area (ZDj) (see FIG. 3).

In order to guide the final choice of the user (U) from among the proposals submitted and, in particular, to inform him of the safety-related risks, it may be provided to inform the user (U), where appropriate, that the or at least one of the proposed configurations of the movements planned for the agricultural robot(s) (1) is dangerous because of a slope or other identified risk, or is not optimal for the subsequent agricultural operation.

As shown as an example in FIG. 3, the method may consist, in the case of at least one non-straight edge portion (PC) of a plot of land (P), in generating paths (TC) parallel to the edge portion (PC) and defining a zone (ZC), the extension of each of the paths (TC) being limited by their intersection with the edge of the plot (P) and/or with a straight path (Ti).

More generally, when the reference orientation (OR1) and/or when another subsequent reference orientation (ORi) is associated with a non-straight reference edge (BR1, BRi), the paths (T1, Ti) calculated follow the course of the edges in a parallel manner, hence in a non-straight path.

The invention also relates to a method for working a plot of land (P) by means of at least one agricultural robot (1), characterised in that it comprises a preliminary parameter-setting and programming phase including at least one method for determining semi-automatically the passages and paths (T) to be made, as described above.

After it has been defined automatically or semi-automatically and the final selection has been made by the user, the proposed paths configuration (Ti) selected for implementation is sent to the robot(s) (1) so that it (they) can carry out the programmed work on the plot (P) in question, the calculation operations and the transmission of the configuration being carried out, for example, by a supervisor system or by a mobile terminal made available to the user.

The actual work on the plot can then be carried out, for example, in accordance with the methods described in the applicant's documents FR3119508, FR3114218, FR3114217, FR3119507 and FR3122063.

A practical example of how the method works is as follows: the user connects to a web application via their computer/tablet/smartphone. He/She then accesses a list of existing plots, to which he/she can add a new plot if required. He/She retrieves (using data measured in the field) or draws by hand the outer edge of his/her plot. This is followed by the stages of the method according to the invention described above. The result of this method is a file containing the geometry (lines configuration) generated by the user. This file can be distributed to the robot(s), which will implement it via supervision software that will generate control commands for the robot(s).

Existing software that can be used by the invention to carry out certain tasks or operations in the context of practical implementation of the method described above, either directly or by adapting their implementation to the needs of the invention, include known software for importing and/or drawing maps of plots or fields from satellite images, generating optimised parallel guide lines and exporting them to a terminal for subsequent use by an autonomously guided tractor (for example: the “Geo-Bird” software from AGCO or the “FieldPlanner” software from Lacos Computer Service). In particular, such software needs to be adapted or implemented in relation to multiple reference edges or directions. Another example involves software for generating a set of parallel lines along a reference line (for example: CCI. Command and Parallel Tracking functions of CCI terminal).

Of course, the invention is not limited to the embodiment described and shown in the attached drawings. Modifications remain possible, in particular from the point of view of the constitution of the various elements or by substitution of technical equivalents, without however leaving the field of protection of the invention.

1. A method for determining semi-automatically the passages and paths to be made by an agricultural robot in order to work a given plot of land in its entirety, the method comprising:
a) defining, automatically or by a user, an initial reference orientation, advantageously in accordance with a reference edge of the plot in question,
b) calculating paths parallel to the initial reference orientation, so as to cover the entire plot,
c) automatically detecting one or more areas of the plot, with i varying from 2 to n, with n≥2, called non-optimal area(s), in which the evaluation, with respect to a predefined performance criteria related to the paths and/or work, of the planned paths in accordance with the initial reference orientation and of the resulting configuration of the projected movements, does not exceed a threshold value or does not reach a respectively predetermined optimal value,
d) automatically defining another reference orientation for the or each non-optimal area(s),
e) calculating, for the or each non-optimal area(s), the paths parallel to the other reference orientation defined for the non-optimal area in question, so as to cover this non-optimal area in its entirety in each case,
f) if necessary, repeating steps d) and e) for a given non-optimal area, defining a different reference orientation in each case, until a paths proposal is obtained for this non-optimal area, whose evaluation with respect to the performance criteria reaches an optimal value,
g) visualizing the plot of land with a proposal for the configuration of the projected movements of the agricultural robot(s) in the different areas, each with its own paths orientations, these different areas, with i varying from 1 to n, together covering the entire surface of the plot of land.

2. The method according to claim 1, wherein the visualization of the projected movement configuration proposal(s) for the agricultural robot(s) on the plot of land divided into n zones is carried out on an interactive graphic interface and the proposal, possibly chosen from several after a justified selection, is subject to validation by a user before being transmitted to the agricultural robot(s), if necessary via a centralized management system of the latter(s).

3. The method according to claim 1, wherein the initial reference orientation is defined, after taking into account the topographic and geometric features of the plot of land, by using an evaluation criteria chosen from among the following: a given number of projected paths, for example a minimum number; a given number of U-turns, for example a minimum number; the longest possible uninterrupted edge-to-edge path, straight if possible; an optimized statistical parameter on the population of projected paths lengths, for example variance, average and/or median; whereby a weighting of the criteria can be applied if at least two criteria are used.

4. The method according to claim 1, wherein the evaluation criteria used to detect areas as not being likely to be travelled and/or worked efficiently enough in relation to the initial paths prediction, is/are chosen from among the following: the topography and/or geometry of the plot of land; an average value of the paths' lengths that is as high as possible; a number of U-turns that is as low as possible; a statistical parameter optimized on the population of the projected paths' lengths, for example the variance, the average and/or the median; a weighting of the criteria possibly being applied when at least two criteria are used.

5. The method according to claim 1, the method further comprising defining limits at the junction regions between two abutting zones, among the various n zones covering the entire surface of the plot, giving preference as criteria to a minimum number of paths, with i varying from 1 to n, to cover the entire plot and/or a minimum number of U-turns within the plot.

6. The method according to claim 5, wherein the definition of each limit at the junction region between two abutting areas, with i varying from 1 to n, is achieved either by connecting two opposite points of the peripheral edge surrounding the plot, or by extending the paths of an area from the peripheral edge to their intersection with another path of greater length of another zone, this definition of the limits being carried out automatically or manually by a user by an interactive graphic interface.

7. The method according to claim 1, the method further comprising taking into account during steps a), b), d) and e), on the basis of enhanced cartographic data of the plot and for the definition of the initial reference orientation, and of another possible reference orientation, as well as for the subsequent calculation of the paths: one or more obstacles that may be present in the plot and/or one or more risk zones that may be present in the plot, and/or the intended direction of movement during a subsequent agricultural operation.

8. The method according to claim 1, the method further comprising taking into account three-dimensional topographic data for the plot in question, to identify the area(s) which may be on a slope and whose gradient is greater than a predetermined threshold value, and to impose a reference orientation for the orientation of the paths, with j≥0, to be calculated for the or each agricultural robot(s) in the or each aforementioned area.

9. The method according to claim 1, method further comprising informing the user, where appropriate, that the or proposed configuration(s) of the movements planned for the agricultural robot(s) is dangerous because of a slope or other identified risk, or is not optimal for the subsequent agricultural operation.

10. The method according to claim 1, the method further comprising, in the case of a non-straight edge portion of a plot of land, in generating paths parallel to the edge portion and defining a zone, the extension of each of the paths being limited by their intersection with the edge of the plot and/or with a straight path.

11. A method for working a plot of land by an agricultural robot, wherein the method comprises a preliminary parameter-setting and programming phase including a method for determining semi-automatically the passages and paths to be made according to claim 1.
